(19) United States
(12) Patent Application Publication
(10) Pub. No.: US 2021/0385919 A1
(43) Pub. Date: Dec. 9, 2021

(54) LIGHT CONTROLLING DEVICE OF IMAGE CAPTURING MECHANISM

(71) Applicant: Tsai-Tzu LIAO, New Taipei City (TW)

(72) Inventor: Tsai-Tzu LIAO, New Taipei City (TW)

(21) Appl. No.: 16/893,438

(22) Filed: Jun. 5, 2020

(51) Int. Cl. H05B 45/325; H05B 45/12

(52) U.S. Cl. CPC H05B 45/325; H05B 45/12

(57) ABSTRACT

A light controlling device of image capturing mechanism, which includes: an image capturing mechanism; a light source controlling mechanism, connected to the image capturing mechanism and capable of identifying an image signal of the image capturing mechanism within a range of 15 Hz to 60 Hz; a pulse wave controlling mechanism, connected to the light source controlling device and capable of receiving a signal which is identified by the light source controlling mechanism so as to generate a pulse wave signal; and a lighting mechanism, connected to the pulse wave controlling mechanism and utilized for receiving the pulse wave signal generated by the pulse wave controlling mechanism, wherein the signal is served as a determination factor for lighting. Accordingly, effects of allowing the lighting mechanism to consume less power, to be provided with high stability and to be provided with a prolonged service life can be achieved.

### BACKGROUND OF THE INVENTION

### 1. Field of the Invention

The present invention relates to a light controlling device of image capturing mechanism, especially to a light controlling device of image capturing mechanism capable of adjusting and controlling the illumination requirement of a lighting mechanism according to the environmental brightness changes in a location where an image capturing mechanism is disposed, so that the lighting mechanism can be in an optimal status to have the best performance with a proper power consumption, thus effects of allowing the lighting mechanism to consume less power, to be provided with high stability and to be provided with a prolonged service life can be achieved.

### 2. Description of Related Art

The structure of a conventional infrared illuminating device is consisted of a lighting device, a switch unit, a synchronized signal capturing module, a signal modifying module, a drive module, a power converting module, an AC power source and an infrared camera, wherein the switch unit is coupled to the lighting device and utilized for controlling whether infrared light emitting diodes bring conducted; the synchronized signal capturing module is coupled to the infrared camera and capable of receiving an original image signal and capturing the vertical synchronizing output of the original image signal; the signal modifying module is coupled to the synchronized signal capturing module and capable of receiving the vertical synchronizing signal for being modified so as to be output a synchronizing drive signal; the drive module is coupled to the signal modifying module and capable of receiving the synchronizing drive signal so as be amplified, thereby driving the switch unit to be opened or closed, thus the infrared light emitting diodes can be controlled whether to be lit or not, thereby generating an infrared illuminating light source.

However, for the above-mentioned infrared illuminating device, when a power converting operation is processed, a situation of voltage shifting often happens, if the lighting device with fixed voltage works with the switch unit, the working current would also be in a shifting status; moreover, the above-mentioned infrared illuminating device is unable to adjust the illumination requirement of lighting units according to the changes of illuminance at a location where the camera is disposed, so that the lighting units cannot be in an optimal performing status, and disadvantages of the lighting units consuming a lot of energy, have low stability and have lower service life are caused.

For solving the disadvantages existed in the prior art, the applicant of the present invention has devoted himself for developing a light controlling device of image capturing mechanism with a hope of effectively improving the above-mentioned disadvantages.

### SUMMARY OF THE INVENTION

One primary objective of the present invention is that when a lighting mechanism is utilized for providing auxiliary illumination to an image capturing mechanism, the illumination requirement of the lighting mechanism can be adjusted and controlled via a light source controlling mechanism and a pulse wave controlling mechanism according to the environmental brightness changes in the location where the image capturing mechanism is disposed, so that the lighting mechanism can be in an optimal status to have the best performance with a proper power consumption, thus effects of allowing the lighting mechanism to consume less power, to be provided with high stability and to be provided with a prolonged service life can be achieved.

For achieving the above-mentioned objective, the present invention provides a light controlling device of image capturing mechanism, which includes: an image capturing mechanism, a light source controlling mechanism, connected to the image capturing mechanism and capable of identifying an image signal of the image capturing mechanism within a range of 15 Hz to 60 Hz, a pulse wave controlling mechanism, connected to the light source controlling device and capable of receiving a signal which is identified by the light source controlling mechanism so as to generate a pulse wave signal; and a lighting mechanism, connected to the pulse wave controlling mechanism and utilized for receiving the pulse wave signal generated by the pulse wave controlling mechanism, wherein the signal is served as a determination factor for lighting.

According to one embodiment provide by the present invention, the image capturing mechanism has a photographing unit, an image field signal processing interface unit connected to the photographing unit, and an environmental brightness detector connected to the light source controlling mechanism.

According to one embodiment provide by the present invention, the light source controlling mechanism has a brightness controlling unit connected to the environmental brightness detector and the pulse wave controlling mechanism, a NTSC/PAL identifying unit connected to the image filed signal processing interface unit, a photographing signal shape processing unit connected to the image field signal processing interface unit and the NTSC/PAL identifying unit, and a photographing signal frequency identifying unit connected to the photographing signal shape processing unit.

According to one embodiment provide by the present invention, the NTSC/PAL identifying unit is able to identify an image signal within a frequency of 50 Hz to 60 Hz.

According to one embodiment provide by the present invention, the photographing signal shape processing unit is able to identify an image signal with a frequency of 15 Hz to 60 Hz.

According to one embodiment provide by the present invention, the pulse wave controlling mechanism has a pulse wave frequency setting unit connected to the photographing signal frequency identifying unit, a pulse wave signal generator connected to the brightness controlling unit and the pulse wave frequency setting unit, a pulse wave width adjusting unit connected to the pulse wave signal generator, and a pulse wave output current driving unit connected to the pulse wave width adjusting unit.

According to one embodiment provide by the present invention, the lighting mechanism has a current amplifying driving unit connected to the pulse wave output current driving unit and a plurality of light emitting diodes connected to the current amplifying driving unit.

### BRIEF DESCRIPTION OF THE DRAWINGS

FIG. 1 is a schematic view showing a fundamental frame according to the present invention; and

FIG. 2 is a schematic view showing a time sequence of outputting pulse wave according to the present invention.

### DESCRIPTION OF THE CODES

1: Image capturing mechanism

11: Photographing unit

12: Image field signal processing interface unit

13: Environmental brightness detector

2: Light source controlling mechanism

21: Brightness controlling unit

22: NTSC/PAL identifying unit

23: Photographing signal shape processing unit

24: Photographing signal frequency identifying unit

3: Pulse wave controlling mechanism

31: Pulse wave frequency setting unit

32: Pulse wave signal generator

33: Pulse wave width adjusting unit

34: Pulse wave output current driving unit

4: Lighting mechanism

41: Current amplifying driving unit

42: Light emitting diode

### DETAILED DESCRIPTION OF THE PREFERRED EMBODIMENT

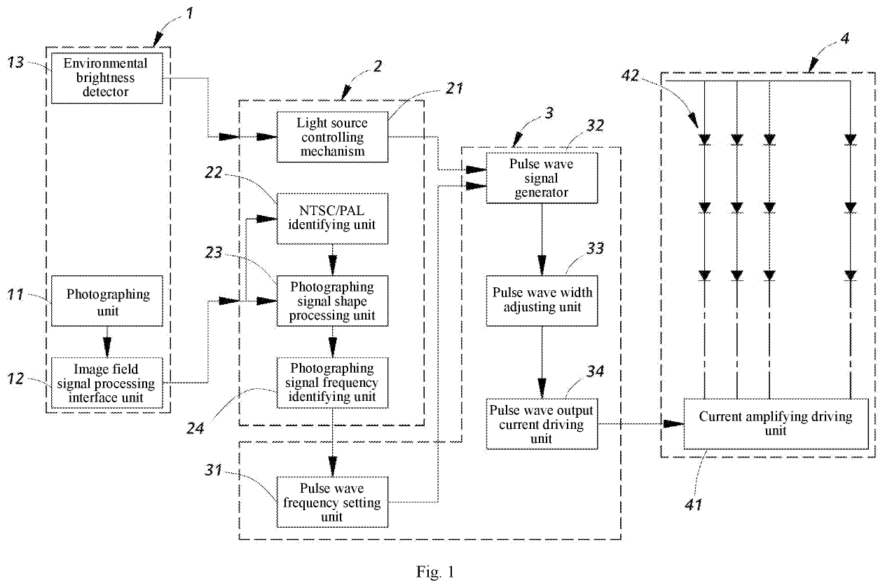

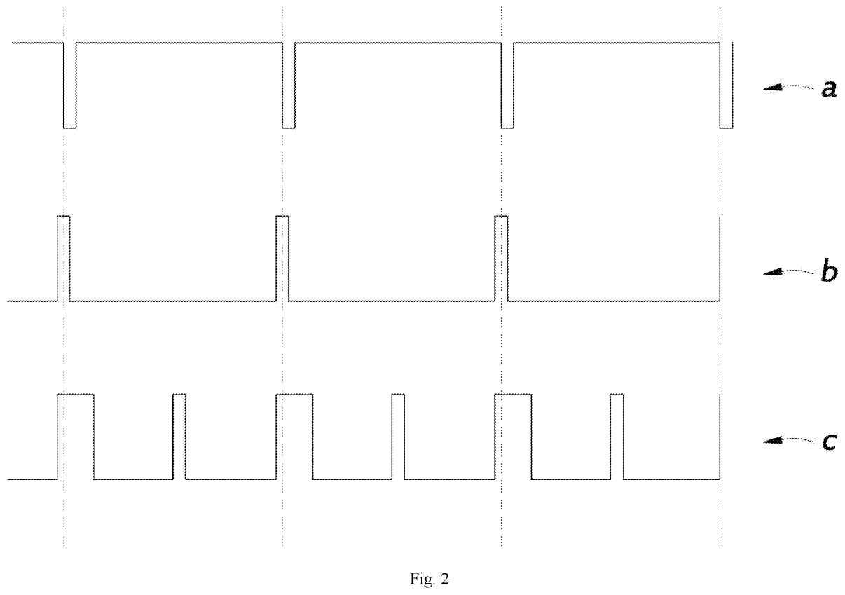

Please refer to FIG. 1 to FIG. 2, wherein FIG. 1 is a schematic view showing a fundamental frame according to the present invention; and FIG. 2 is a schematic view showing a time sequence of outputting pulse wave according to the present invention. As shown in figures, the present invention provides a light controlling device of image capturing mechanism, which at least includes an image capturing mechanism 1, a light source controlling mechanism 2, a pulse wave controlling mechanism 3 and a lighting mechanism 4.

The image capturing mechanism 1 has a photographing unit 11, an image field signal processing interface unit 12 connected to the photographing unit 11 and an environmental brightness detector 13 connected to the light source controlling mechanism 2.

The light source controlling mechanism 2 is able to identify an image signal of the image capturing mechanism 1 within a range of 15 Hz to 60 Hz, and the light source controlling mechanism 2 has a brightness controlling unit 21 connected to the environmental brightness detector 13, a NTSC/PAL identifying unit 22 connected to the image filed signal processing interface unit 12, a photographing signal shape processing unit 23 connected to the image field signal processing interface unit 21 and the NTSC/PAL identifying unit 22, and a photographing signal frequency identifying unit 24 connected to the photographing signal shape processing unit 23, wherein the NTSC/PAL identifying unit 22 is able to identify an image signal within a frequency of 50 Hz to 60 Hz, and the photographing signal shape processing unit 23 is able to identify an image signal with a frequency of 15 Hz to 60 Hz.

The pulse wave controlling mechanism 3 is utilized for receiving a signal which is identified by the light source controlling mechanism 2 so as to generate a pulse wave signal, and the pulse wave controlling mechanism 3 has a pulse wave frequency setting unit 31 connected to the photographing signal frequency identifying unit 24, a pulse wave signal generator 32 connected to the brightness controlling unit 21 and the pulse wave frequency setting unit 31, a pulse wave width adjusting unit 33 connected to the pulse wave signal generator 32, and a pulse wave output current driving unit 34 connected to the pulse wave width adjusting unit 33.

The lighting mechanism 4 is utilized for receiving the pulse wave signal generated by the pulse wave controlling mechanism 3, and the above-mentioned signal is served as a determination factor for lighting, and the lighting mechanism 4 has a current amplifying driving unit 41 connected to the pulse wave output current driving unit 34 and a plurality of light emitting diodes 42 connected to the current amplifying driving unit 41.

When the present invention is in use, the environmental brightness detector 13 is utilized for detecting the changes of illuminance where the image capturing unit 11 is disposed, and not actuated if a sufficient environmental illuminance is detected by the environmental brightness detector 13 and actuated if an insufficient environmental illuminance is detected, and a signal is sent to the brightness controlling device 21, at this moment the image capturing unit 11 is able to obtain an original signal of an image via the image filed signal processing interface unit 12, and the original signal of the image is sent to the NTSC/PAL identifying unit 22 and the photographing signal shape processing unit 23, so that an image field frequency can be identified by the NTSC/PAL identifying unit 22 or the photographing signal shape processing unit 23 respectively according to the difference of a signal source while an image field period being served as a reference, thereby allowing the relevant image field signal (as shown in part a of FIG. 2) to be automatically separated, the photographing signal frequency identifying unit 24 can be utilized for automatically identifying the frequency thereof to be 50 Hz or 60 Hz, thus a real frequency is obtained after the identifying process, and the pulse wave frequency setting unit 31 is utilized for modifying the wave shape in the frequency then being sent to the pulse wave signal generator 32, the pulse wave signal generator 32 is able to receive the signals of the environmental brightness detector 13 and the pulse wave frequency setting unit 31 so as to be actuated, when the field image frequency is higher than 30 Hz, the pulse wave signal generator 32 is able to work with the pulse wave width adjusting unit 33, so that a 1.2-millisecond pulse wave signal (as shown in part b of FIG. 2) is generated within 1.2 millisecond defined an accumulated time of 0.8 millisecond before a descent edge and 0.4 millisecond after the descent edge in each image field signal period, and the pulse wave signal is sent by the pulse wave output current driving unit 34 to the current amplifying driving unit 41 of the lighting mechanism 4, thereby enabling each of the light emitting diodes 42 to be lit; on the other hand, when the image field frequency is lower than 30 Hz (as shown in part c of FIG. 2), the pulse wave signal generator 32 can automatically change the frequency and work with the pulse wave width adjusting unit 33 to generate a frequency changed wave width adjusting signal with an original image field signal phase being served as a reference, so that the frequency changed wave width adjusting signal is outputted by the pulse wave output current driving unit 34 to the current amplifying driving unit 41 of the lighting mechanism 4, thereby enabling each of the light emitting diodes 42 to be lit.

Based on what has been disclosed above, disadvantages exited in the prior art which are improved by the light controlling device of image capturing mechanism of the present invention are as follows: when the lighting mechanism is utilized for providing auxiliary illumination to the image capturing mechanism, the illumination requirement of the lighting mechanism can be adjusted and controlled via the light source controlling mechanism and the pulse wave controlling mechanism according to the environmental brightness changes in the location where the image capturing mechanism is disposed, so that the lighting mechanism can be in an optimal status to have the best performance with a proper power consumption, thus effects of allowing the lighting mechanism to consume less power, to be provided with high stability and to be provided with a prolonged service life can be achieved; accordingly, the light controlling device of image capturing mechanism provided by the present invention is novel, more practical in use, and can satisfy the needs required by consumers.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A light controlling device of image capturing mechanism, used for being connected to an electronic camera for operation, and including:
a light source controlling mechanism, connected to the image capturing mechanism and capable of identifying an image signal of the image capturing mechanism within a range of 15 Hz to 60 Hz;
a pulse wave controlling mechanism, connected to the light source controlling device and capable of receiving a signal identified by the light source controlling mechanism so as to generate a pulse wave signal; and
a lighting mechanism, connected to the pulse wave controlling mechanism and utilized for receiving the pulse wave signal generated by the pulse wave controlling mechanism, wherein the signal is served as a determination factor for lighting.

2. The light controlling device of image capturing mechanism as claimed in claim 1, wherein the image capturing mechanism has a photographing unit, an image field signal processing interface unit connected to the photographing unit, and an environmental brightness detector connected to the light source controlling mechanism.

3. The light controlling device of image capturing mechanism as claimed in claim 2, wherein the light source controlling mechanism has a brightness controlling unit connected to the environmental brightness detector and the pulse wave controlling mechanism, a NTSC/PAL identifying unit connected to the image filed signal processing interface unit, a photographing signal shape processing unit connected to the image field signal processing interface unit and the NTSC/PAL identifying unit, and a photographing signal frequency identifying unit connected to the photographing signal shape processing unit.

4. The light controlling device of image capturing mechanism as claimed in claim 3, wherein the NTSC/PAL identifying unit is able to identify an image signal within a frequency of 50 Hz to 60 Hz.

5. The light controlling device of image capturing mechanism as claimed in claim 3, wherein the photographing signal shape processing unit is able to identify an image signal with a frequency of 15 Hz to 60 Hz.

6. The light controlling device of image capturing mechanism as claimed in claim 3 wherein the pulse wave controlling mechanism has a pulse wave frequency setting unit connected to the photographing signal frequency identifying unit, a pulse wave signal generator connected to the brightness controlling unit and the pulse wave frequency setting unit, a pulse wave width adjusting unit connected to the pulse wave signal generator, and a pulse wave output current driving unit connected to the pulse wave width adjusting unit.

7. The light controlling device of image capturing mechanism as claimed in claim 6, wherein the lighting mechanism has a current amplifying driving unit connected to the pulse wave output current driving unit and a plurality of light emitting diodes connected to the current amplifying driving unit.
